(19) United States
(12) Patent Application Publication
(10) Pub. No.: US 2017/0116827 A1
(43) Pub. Date: Apr. 27, 2017

(54) SYSTEM AND WEARABLE DEVICE FOR EVENT NOTIFICATIONS

(71) Applicant: NARRATIVE MARKETING, INC., New York, NY (US)

(72) Inventors: Tricia Clarke-Stone, New York, NY (US); Seth Mills, Brooklyn, NY (US); Ricky Bacon, Jersey City, NJ (US)

(21) Appl. No.: 15/173,172

(22) Filed: Jun. 3, 2016

Related U.S. Application Data
(60) Provisional application No. 62/245,342, filed on Oct. 23, 2015.

(51) Int. Cl. G08B 7/06; G08B 25/10

(52) U.S. Cl. CPC G08B 7/06; G08B 25/10

(57) ABSTRACT

Provided is a wearable device, system, and method, for providing real-time event notifications. In one example, a wearable device includes at least one light source, a display surface in optical communication with the at least one light source, communication circuitry configured to receive an event message in real-time from a user device, and at least one controller operatively connected to the at least one light source and the communication circuitry, the at least one controller configured to control operation of the at least one light source based on the received event message.

### CROSS-REFERENCE TO RELATED APPLICATIONS

This application claims priority under 35 U.S.C. §119(e) to U.S. Provisional Application Ser. No. 62/245,342, titled “SYSTEM AND WEARABLE DEVICE FOR EVENT NOTIFICATIONS,” filed on Oct. 23, 2015, which is hereby incorporated herein by reference in its entirety.

### BACKGROUND

Display devices such as billboards, signs, posters, flyers, and letters, are frequently used to provide information to targeted viewers. Often such information may include conveyances such as advertisements, pictures, slogans, or other types of information. Particular wearable display devices offer the benefit of increased mobility and convenience, allowing the user to transport and/or distribute the information. Such wearable display devices are often popular at concerts, sports events, and other large gatherings because they allow the user to show their support or connection with a particular team, individual, or cause, without inhibiting movement or mobility.

### SUMMARY OF THE INVENTION

According to various aspects of the present invention, a system and wearable device capable of generating real-time event notifications is provided. The wearable device is specially-configured to generate a visual notification and/or a haptic (e.g., vibration) notification responsive to receiving an indication that an event, such as a goal at a sporting event, or other related activity, has occurred. In particular, the wearable device of various embodiments is configured to generate an event notification based on particular event data or metadata associated with the event that occurred. Each event notification may be unique to particular event data (e.g., the start of a game, occurrence of a goal or point, occurrence of an assist, crowd noise, etc.). For instance, the wearable device may include one or more light sources and one or more vibration sources that may be controlled based on the particulars of the event.

In particular, embodiments may further include application systems, applications, and methods for providing real-time event notifications at a wearable device, and for efficiently managing data transmission and communication with the wearable device. Accordingly, aspects and embodiments discussed herein, provide a user with greater access to more timely and relevant event information, and in particular, to real-time event updates. Further advantages and benefits of aspects and embodiments described herein are discussed within the contents of U.S. Provisional Application Ser. No. 62/245,342, titled “SYSTEM AND WEARABLE DEVICE FOR EVENT NOTIFICATIONS,” filed on Oct. 23, 2015, which is incorporated herein by reference in its entirety.

According to one aspect, provided is a wearable device. In one example, the wearable device includes at least one light source, a display surface in optical communication with the at least one light source, communication circuitry configured to receive an event message in real-time from a user device, and at least one controller operatively connected to the at least one light source and the communication circuitry, the at least one controller configured to control operation of the at least one light source based on the received event message.

In one embodiment, the at least one light source includes at least one light-emitting diode (LED) unit. According to an embodiment, the display surface includes at least one visual indicator, and in controlling operation of the at least one light source based on the received event message, the controller is further configured to activate the at least one LED unit based on an illumination pattern specifying a color, an intensity, and a duration of activation, to illuminate the visual indicator. In an embodiment, the at least one LED unit includes a plurality of LED units, each LED unit of the plurality being independently addressable, and the illumination pattern includes a sequence of analog power values each corresponding to the color, the intensity, the duration of activation, and a timing of activation for each LED unit of the plurality of LED units. According to one embodiment, the event message includes translated event metadata received from a push notification service and associated with an event, and the controller is further configured to dynamically determine the illumination pattern based on at least the event metadata.

According to an embodiment, the wearable device further includes a housing having an attachment surface including an attachment article configured to selectively fasten the wearable device to a user. In one embodiment, the wearable device further includes a vibration motor, and the controller is configured to activate the vibration motor based on the received event message. In a further embodiment, in activating the vibration motor based on the received event message, the controller is configured to generate a pulse width modulation (PWM) waveform based on a haptic pattern to activate the vibration motor for a predetermined intensity and a predetermined duration of activation. In an embodiment, the communication circuitry includes a wireless receiver configured to receive the event message from the user device via a wireless protocol, and the wireless protocol implements a short range piconet. According to an embodiment, the wearable device further includes a Near-Field Communication (NFC) chip configured to communicate with the user device according to a near-field communication protocol.

According to an aspect, provided is a system for real-time event notifications. In one example, the system includes a first user device including a memory, a user display, and at least one processor in communication with the memory and the user display, the processor when executing configured to: receive event data from a push notification service, serialize and transmit an event message, and a first wearable device including communication circuitry configured to receive the event message, a controller, and at least one light source in optical communication with a display surface, the controller being configured to control operation of the at least one light source based on the received event message.

In an embodiment, the communication circuitry includes a wireless receiver configured to receive the event message from the user device via a wireless protocol, and the event data includes event metadata received from the push notification service and corresponding to an event. According to one embodiment, the at least one light source includes at least one light-emitting diode (LED) unit, the display surface further includes at least one visual indicator, and in controlling operation of the at least one light source based on the received event message, the controller is further configured to activate the at least one LED unit based on an illumination pattern including a color, an intensity, and a duration of activation, to illuminate the visual indicator. In an embodiment, the controller is further configured to dynamically determine the illumination pattern based on at least the event metadata.

According to an embodiment, the processor of the first user device when executing is further configured to manage interactive display of the event data and event metadata via the user display of the user device. In an embodiment, the processor of the first user device when executing is further configured to communicate via a multi-peer connectivity network with a second user device, and the first wearable device is configured to sync with a second wearable device, the second wearable device configured to receive the event message from the second user device.

According to an aspect, provided is a method for real-time event notifications. In one example, the method includes aggregating event data, receiving event data via at least one push notification service at a first user device, serializing and transmitting an event message to a first wearable device based at least in part on the event data, and responsive to receiving the event message at the first wearable device, providing one of a visual notification and a haptic notification based on the event message.

In an embodiment, the first wearable device includes a visual indicator in optical communication with at least one light-emitting diode (LED) unit, and providing the visual notification includes activating the at least one LED unit based on an illumination pattern including a color, an intensity, and a duration of activation, to illuminate the visual indicator. According to one embodiment, the method further includes translating event metadata of the event data, the event metadata being associated with an event, and dynamically determining the illumination pattern based on at least the event metadata, responsive to receiving the event message at the first wearable device.

According to an embodiment, the method further includes interactively displaying the event data and event metadata via a user display of the first user device. In one embodiment, the method further includes communicating via a multi-peer connectivity network with a second user device, and syncing the first wearable device with a second wearable device, the second wearable device being in communication with the second user device.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is an example system for event notifications according to aspects of the invention;

FIGS. 2A-2D illustrate an example of multi-peer connectivity according to aspects of the invention;

FIGS. 3A-3D are example illustrations of a wearable device according to aspects of the invention;

FIG. 4 is an example block diagram of a wearable device according to aspects of the invention;

FIG. 5 is an example schematic illustration of a wearable device according to aspects of the invention;

FIGS. 6A and 6B is an example process flow for providing an event notification, according to aspects of the invention;

FIG. 7 is an example process flow for transitioning a visual display of a user interface according to aspects of the invention;

FIGS. 8A-8E are example illustrations of visual displays of a user interface according to aspects of the invention; and

FIG. 9 is an illustrated a block diagram of a distributed computer system, in which various aspects and functions are practiced.

### DETAILED DESCRIPTION

According to various aspects and embodiments, a system and wearable device capable of generating real-time event notifications is provided. The wearable device is specially-configured to generate a visual notification and/or a haptic (e.g., vibration) notification responsive to receiving an indication that an event has occurred. In various embodiments, the wearable device is configured to attach to the clothing or body of a user and notifies the user, and those in an immediate proximity to the user, regarding events and other occurrences. For example, in various embodiments the wearable device may be in communication with a user device which includes controls that perform various functions in an application (e.g., a mobile application) to provide to the wearable device real-time event messages descriptive of event data. The user device of various embodiments may be adapted to stream event data in real-time from one or more content sources as events occur, and as such event data and metadata becomes available. Event messages are then communicated via a wireless network connection (i.e., a wireless network protocol) to the wearable device to provide real-time event notifications and updates. Accordingly, aspects and embodiments discussed herein, provide a user with greater access to more timely and relevant event information, and in particular, to real-time event updates.

It is to be appreciated that embodiments of the methods and apparatuses discussed herein are not limited in application to the details of construction and the arrangement of components set forth in the following description or illustrated in the accompanying drawings. The methods, systems, and apparatuses, are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

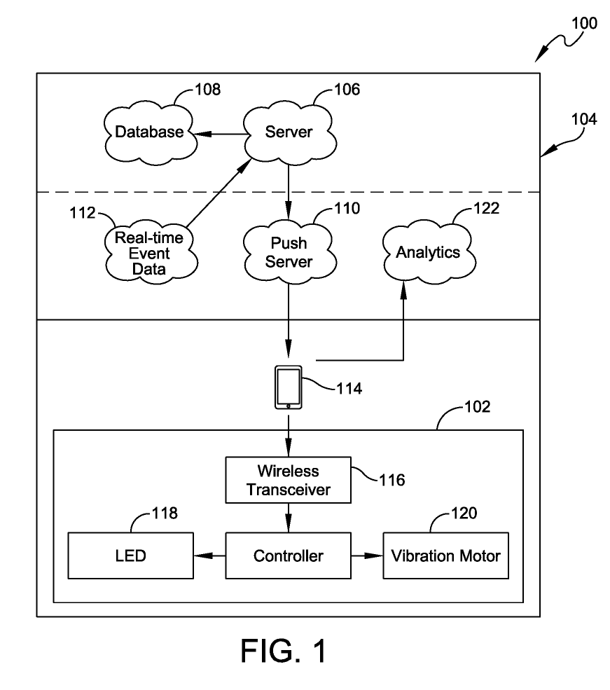

FIG. 1 shows an example event notification system 100 for incorporation of various aspects of the present invention. In one embodiment, the system 100 can include a wearable device 102, a user device 114, and an event notification service (shown generally as 104). In one embodiment, the user device 114 may include a memory, a user interface (e.g., user display screen), and one or more processors. For example, the user device 114 can include a cell phone, smart phone, PDA, tablet computer, laptop, or other mobile device or computing system. Users may operate the user interface of the user device 114 to interact with an event notification application executing on the user device 114 to control and/or interact with the wearable device 102 and the event notification service.

In one embodiment, the event notification service 104 may include one or more computer systems. In one embodiment, the event notification service 104 may be implemented on a distributed computer system using one or more communication networks (e.g., the Internet). In one implementation, the event notification service 104 is implemented in a cloud-based computing platform, such as the well-known EC2 platform available commercially from Amazon.com of Seattle, Wash. Other implementations are possible and are within the scope and spirit of the invention, and it is appreciated that other platforms may be used. In one example, the event notification service 104 may include a webserver 106 and a datastore 108. The user device 114 may receive event data and metadata aggregated and distributed by the event notification service 104.

The event notification service 104 may also provide one or more related services, such as a service for storing event data and metadata, a service for one or more analytics, and/or a push notification service. In various embodiments, services may be integral to the event notification service 104 or may alternatively operate in conjunction with the event notification service 104 (e.g., by communicating with the service 104 through an Application Programming Interface (API)). In particular, FIG. 1 shows the webserver 106 of the event notification service 104 in communication with a third party push notification webserver 110 and one or more third party content sources 112. The push notification webserver 110 couples the event notification service 104 and the user device 114.

In various embodiments, the event notification service 104 receives event data from the one or more third party content sources 112. For instance, event data and metadata may be received and aggregated in real-time by the event notification service 104 via one or more third party APIs. In various embodiments, event data includes sports event data, such as data particular to an occurrence during a given game or match. For example, event metadata may include: a timestamp of each event of the event metadata, one or more teams participating in the sports event, an indication that the sports event has begun, an indication that the sports event has ended, a goal (or point) scored, a player or team assist, and/or a penalty or foul. In particular, event metadata including a goal (or point) scored, may include an amount of goals or points scored, the type of goal or point scored, and/or the team and/or player responsible for the point or goal scored. Event metadata including a player or team assist may similarly include the team and/or the player responsible for the assist. In a further example, event metadata including a penalty or foul may include the type of penalty or foul, the team or player responsible for the penalty or foul, and the duration of the penalty or foul.

While described in one example as including sports event data, in various other embodiments the event data may be related to other types of gatherings, such as celebrity events, live events, or political events, among others. Accordingly, in certain embodiments the event data may include celebrity event data (e.g., celebrity news), political event data (e.g., political news), or live event data (e.g., concert event data). Among other examples, celebrity event data may include celebrity news scraped from one or more Rich Site Summary (RSS) feeds or celebrity news sources. In particular, celebrity event metadata may include: an indication that a celebrity has (or currently is) on tour, the celebrity is at a particular geographic location, the celebrity is involved in industry gossip, the celebrity has won an award, the celebrity is currently on television or the radio, and/or the celebrity has received a role in a film.

Similarly, political event data may be aggregated and received by the event notification service 104 and may include metadata such as: an indication that a politician or political figure is in the news, an indication that a politician or political figure has voted on a law, an indication that a politician has won or lost (or is winning or losing) an election, an indication that a politician has won or lost (or is winning or losing) a nomination, an indication that a political party is in the news, an indication that a member of a political party has won or lost (or is winning or losing) an election, and/or an indication that a member of a political party has won or lost (or is winning or losing) a nomination.

In another example, concert event data may include on-site concert metadata, or off-site concert metadata. Such metadata may be tied to a geographic location, and in particular the geographic location of the concert event. Examples of on-site metadata may include an indication that the event has begun (such as a band beginning to play), an indication that the event has ended (such as a band finishing a last song), and an indication that a song is being played, to name a few. Examples of off-site metadata may include an indication that an event has been scheduled, a group of individuals will be performing at an event, and/or a time and location of an event.

In various embodiments, the event notification service 104 stores the received and aggregated event data and metadata at one or more data stores (e.g., datastore 108). Event data and metadata may be stored and indexed based on the timestamp, the type of the event data or metadata, the teams or participants of the event data, or in any other fashion suitable for event data and metadata. Stored event data is sent via the push notification service (e.g., via the push notification webserver 110) to the user device 114. While in one embodiment, event data may be communicated to the user device 114 as discrete communications, in various other implementations the user device 114 may stream a sequence of event data over a given time period. The user device 114 of FIG. 1 is shown as a single user device for ease of explanation only. In various additional embodiments, the system 100 may include any number of user devices 114, each being adapted to receive event data and metadata from the event notification service.

As described above, the push notification service (i.e., the push notification webserver 110) sends the event data to the user device 114. In one implementation, the user device 114 must first subscribe to the push notification service before receiving the event data. In various embodiments, subscribing to the push notification service may include obtaining a device token as is understood in the art. In particular, the user of the user device 114 may subscribe to the push notification webserver 110 when the user accepts access permissions for user device resources.

The push notification service may send the event data and metadata to an event notification application executing on the user device 114. As discussed above, in various embodiments, the event notification application may include an event notification mobile application executing on a cell phone or smart phone. Accordingly, in various embodiments the user device 114 may receive the event data and metadata as a push notification. In one instance, the event notification mobile application receives event data and metadata from the push service via a WebSocket connection, allowing continuous push notifications. In various other embodiments, any other suitable notification channel may be used instead of a push notification service.

As shown in FIG. 1, the user device 114 may also receive one or more event analytics from a third party analytics source 122, and/or from the event notification service 104. Event analytics may include statistics or additional analysis corresponding to a given event or event data. Event analytics corresponding to events may include historical event data, or predicted event data. In one example, event analytics for a basketball game may include a team's win-loss record, or a player's points-per-game, rebounds-per-game, assists-per-game, or steals-per-game rating.

In certain embodiments, the user device 114 is configured to indicate to the event notification service 104 the event data, event metadata, or analytics, desired by the user. For instance, the user device 114 may be configured to receive an input from the user indicating the user's presence at particular event (e.g., a basketball game), and request event data for that particular event. In another example, the user device 114 may be configured to automatically request event data for an event based on proximity of the user's current geographic location and a geographic location of that event. For example, the user device 114 may be configured to identify and request event data or metadata for a given event based on current GPS coordinates of the user relative to GPS coordinates of an event in progress.

In one embodiment, the wearable device 102 includes a NFC (Near-Field Communication) chip configured to communicate and transfer data with the user device 114 according to a near-field communication protocol. Specifically, the NFC chip of the wearable device 102 may perform a specified task when a corresponding NFC enabled device (such as the user device 114) is within a communication range. In one example, the communication range is a radius of about 10 cm (i.e., about 4 inches). When within the communication range, the NFC chip of the wearable device 102 may automatically cause the user device 114 to pin the current geographic location associated with the user. For instance, the user device 114 may pin the current geographic location within a mobile mapping service, which may determine the current geographic location by a GPS-based service or triangulation. One example of a mobile mapping service may include the GOOGLE MAPS™ service offered by Google Inc. of Mountain View, Calif. Accordingly, in various embodiments, communication between the NFC chip of the wearable device 102, and the user device 114, may serve to track a user's favorite geographic locations to view a given event, such as a user's favorite seat during a basketball game, in addition to specifying the event data or metadata requested.

In various embodiments the user device 114, and in particular an event notification application executing on the user device 114, transmits a serialized event message to the wearable device 102 based on the received event data and metadata. For example, the user device 114 may be adapted to translate the event data and event metadata into a format that can be transmitted across a network connection, and reconstructed at the wearable device 102. In various embodiments, the user device 114 includes a wireless component having hardware and software configured to perform acts as described herein via a wireless protocol such as BLUETOOTH®, Bluetooth Low Energy (BLE), or WiFi. As used herein, BLUETOOTH® refers to a short range ad hoc network, otherwise known as piconets. In various embodiments, BLE communication is structured as a series of “services” composed of “characteristics”. In further embodiments, the wireless component may include hardware and software to support both BLUETOOTH® and Bluetooth Low Energy. The user device 114 may transmit the event message to the wearable device 102 while continuing to receive event data and metadata from the push notification service. Accordingly, in various embodiments event data and metadata can be read while the event notification application is simultaneously executing on the user device 114. For instance, the event notification mobile application may receive event data and metadata while executing in the foreground of the user device 114. However, in other examples the event notification mobile application may receive event data and metadata while executing in the background of the user device 114, such as via background fetch.

According to various embodiments, the wearable device 102 is adapted to receive the event message transmitted by the user device 114, and generate a visual notification and/or a haptic notification based on the message. For example, a received event message may trigger a sequence of light-emitting diode (LED) animations, a series of timed vibrations, or any combination thereof. In particular, visual and/or haptic notifications may vary depending on the particular event message received, and may be generated based on a pattern (e.g., an illumination pattern or a haptic pattern). In various embodiments, the wearable device 102 includes communication circuitry (e.g., a wireless transceiver 116), at least one light source 118, and at least one motor (e.g., a vibration (“haptic”) motor 120). The illumination pattern may specify a color, an intensity of illumination, a duration of activation, and a timing of activation, of the at least one light source 118, and the haptic pattern may specify an intensity and a duration of activation of the vibration motor 120.

As noted above, in various embodiments the system 100 may include more than one user device subscribed to the event notification service 104, and configured to receive event data. Each user device 114 may be in communication with a respective wearable device 102. Such an arrangement may be advantageous when multiple users in a given geographic location have a similar interest. In such embodiments, each user device may execute the event notification application and sync with the other user devices. For example, the user devices may communicate via a multi-peer connectivity network to further sync each respective wearable device. For instance, multiple user devices and wearable devices at a basketball game may be synced to provide the same illumination or haptic pattern responsive to receiving the same event data.

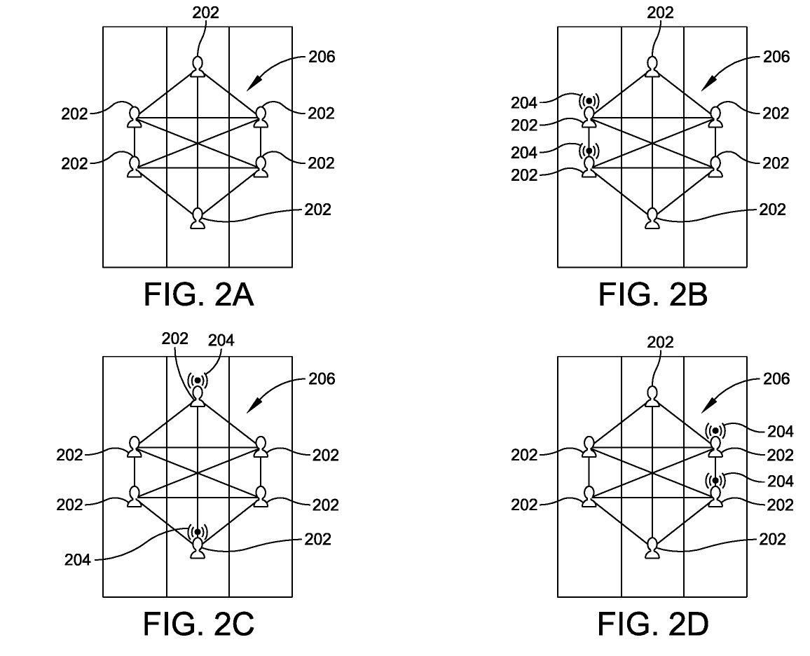

FIGS. 2A-2D illustrate an example of multi-peer connectivity between one or more user devices and wearable devices, according to a particular embodiment. In various embodiments, each synced user device 202 (e.g., a user device 114 as shown in FIG. 1) may receive the same (or similar) event data and metadata and provide one or more related, or similar, event messages to an associated wearable device (e.g., a device 102 as shown in FIG. 1). For example, in one embodiment, the synced wearable devices may be controlled according an illumination pattern that simulates a visual wave effect (known generally as “the wave”). During “the wave”, the light sources of geographically proximate wearable devices are sequentially illuminated. In particular, the progression of FIGS. 2A to 2B, FIGS. 2B to 2C, and FIGS. 2C to 2D, shows the sequential activation of the wearable devices to generate a wave effect. FIG. 2A shows a first moment in time, FIG. 2B shows a second moment in time, FIG. 2C shows a third moment in time, and FIG. 2D shows a fourth moment in time. Lines 206 represent the multi-peer connectivity network between the user devices 202, and indicators 204 represent illuminated wearable devices. While discussed in one example as simulating “the wave”, in various other examples, user devices 202 within the multi-peer connectivity network may display other coordinated or synchronized event notifications, and may allow user interaction with other users and wearable devices.

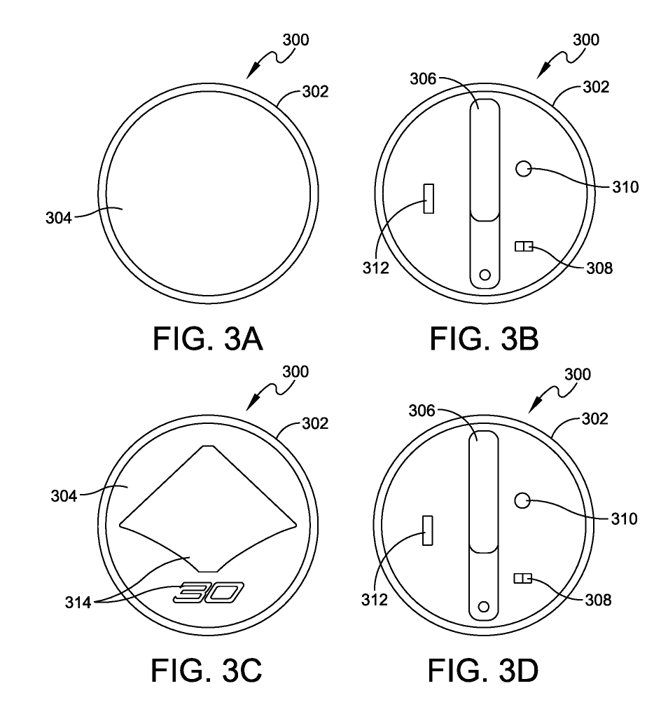

FIGS. 3A and 3B show one example of a wearable device 300 according to various aspects and embodiments. For example, the wearable device 102 discussed with reference to FIG. 1 may include the wearable device 300 shown in FIGS. 3A-3B. In various embodiments, the wearable device 300 is defined by a housing 302 having at least one side facing surface, a frontward facing surface (shown in FIG. 3A), and a rearward facing surface (shown in FIG. 3B). Components of the wearable device 300 such as at least one light source, communication circuitry, and a controller, may be positioned within the housing 302. In certain embodiments, the frontward facing surface of the wearable device 300 may include a display surface 304 in optical communication with the at least one light source (obscured in FIG. 3A by the display surface 304). That is, in various embodiments, the display surface 304 may be positioned to directly, or indirectly (via one or more beamsteering devices), receive light emitted by the at least one light source. The rearward facing surface may include an attachment article 306 for fastening the wearable device 300 to an article of clothing or the body of the user. FIG. 3B shows the rearward facing surface of the wearable device 300 as including an on/off switch 308, a pairing button 310, and a USB (Universal Serial Bus) port 312.

As shown in FIG. 3B, the attachment article 306 may be disposed on a surface distal the display surface 304. Such an arrangement permits the user, and others, to view the display surface 304 when the wearable device 300 is attached to the user. In various embodiments the attachment article 306 may include a hook, a pin, magnetic surface, a series of hook and loop fasteners, a wristband, or any other suitable article for attaching the wearable device. While shown in FIGS. 3A and 3B as having a substantially circular shape, in various other embodiments the housing 302 of the wearable device 300 may take the form of any other suitable shape conducive to providing an event notification.

FIGS. 3C and 3D show a further example of the wearable device 300 described with reference to FIGS. 3A and 3B. In various embodiments, the display surface 304 of the wearable device may include at least one visual indicator 314 in optical communication with the at least one light source and positioned on the display surface 304 to be illuminated by the at least one light source. For instance, FIG. 3C shows the visual indicator 314 having an arrangement of apertures through which light generated by the one or more light source may pass. In one example, such apertures may include a transparent material to prevent ingress of dirt, moisture, and other contaminants while also permitting emission of light. In another example, the display surface 304 may be composed of a transparent material, and the visual indicator 314 may include an opaque material to absorb light such that the visual indicator 314 appears as a silhouette when light passes through the display surface 304. In various embodiments, the at least one visual indicator 314 may correspond to a sports logo, an athlete logo, a brand logo, an event logo, a political logo, a message, a slogan, a name, or any other combination of alphanumeric characters and/or images.

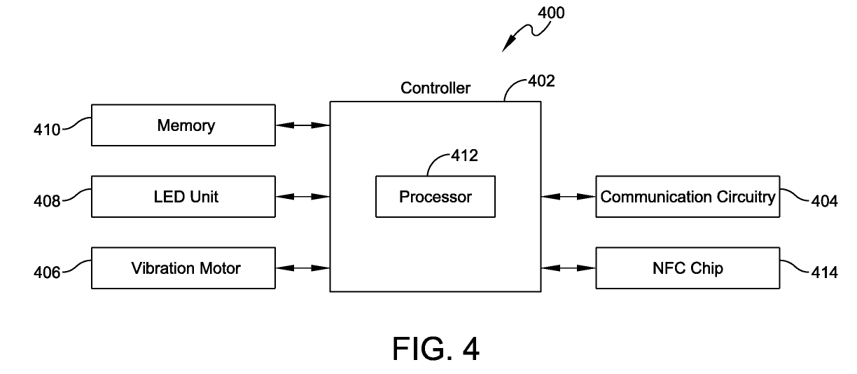

A block diagram of a wearable device 400 of certain embodiments is shown in FIG. 4. For example, the wearable device 102 discussed with reference to FIG. 1 may include the wearable device 400 shown in FIG. 4. The wearable device 400 may include a controller 402, coupled to communication circuitry 404, a vibration motor 406, at least one light source (e.g., a LED unit 408), a NFC chip 414, and memory 410. In particular, the controller 402 may include a processor 412 in electrical communication with each of the communication circuitry 404, the vibration motor 406, the memory 410, and the at least one light source. The controller 402 may include a single controller; however, in various other embodiments the controller 402 may consist of a plurality of controllers and/or control subsystems which may include signal processing circuitry or other control circuitry. In particular, the controller 402 may include analog processing circuitry (e.g., a microcontroller) and/or digital signal processing circuitry (e.g., a digital signal processor (DSP)). For instance, the microcontroller of various embodiments may include a processor core and programmable input/output components. In various embodiments, and as further discussed below, controller 402 may be configured to automatically (and/or dynamically) control various components of the wearable device 400, such as the at least one light source and the vibration motor 406.

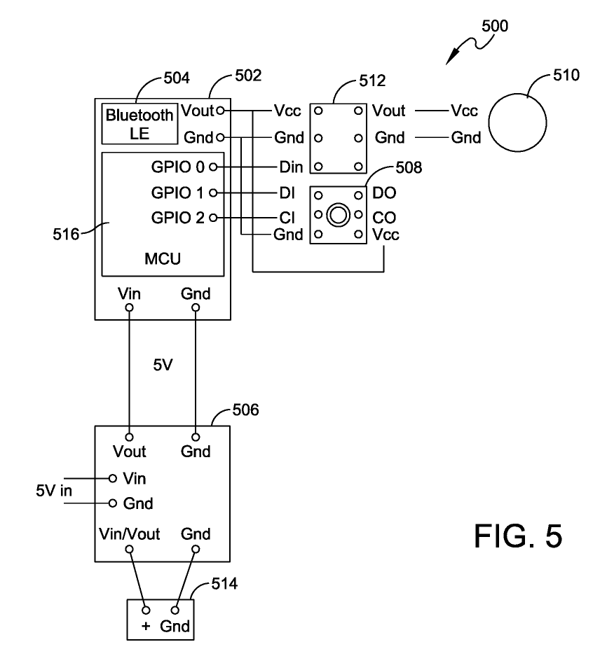

FIG. 5 shows an example schematic illustration of a wearable device 500 of various embodiments. For example, the wearable device 102 discussed with reference to FIG. 1, the wearable device 300 discussed with reference to FIGS. 3A-3D, or the wearable device 400 discussed with reference to FIG. 4, may include the wearable device 500 shown in FIG. 5.

In particular, FIG. 5 shows one example pin layout for the wearable device 500. FIG. 5 shows a controller 502 coupled to communication circuitry 504 (e.g., a wireless transceiver including a Bluetooth Low Energy transceiver), a battery charging circuit 506, at least one light source 508 (e.g., a LED unit), and a vibration motor 510 via a motor controller 512. Specifically, in the shown example, the controller 502 includes a microcontroller unit 516. The battery charging circuit 506 may be further connected to a battery 514 and may include, for example, a buck-boost converter. While FIG. 5 shows one example pin layout, it is appreciated that in further embodiments various other pin layouts may be implemented. Within the schematic illustration of the FIG. 5, “DI” represents a data input, “CI” represents a clock input, “DO” represents a data output, “CO” represents a clock output, “GND” represents a ground pin, “Vin” represents a voltage input pin, “Vout” represents a voltage output pin, “GPIO” represents a general purpose input/output, and “Vcc” represents a power supply pin set to a value of +5V.

In various embodiments, the controller 502 of the wearable device 500 is adapted to control the at least one light source 508, responsive to receiving an event message at the communication circuitry 504. As discussed above, in particular embodiments the controller 502 may be specifically adapted to control a plurality of LED units. In various embodiments, this may cause a display surface of the wearable device 500 (such as the display surface 304 shown in FIG. 3A), or visual indicators on the display of the wearable device 500 (such as the visual indicators 314 shown in FIG. 3C), to glow. In further embodiments, the display surface glows via individually addressable LED units based on the following events: start of a sporting event, when a player scores, when a team is winning or losing and, when a player assists a goal or point.

In various embodiments, the controller 502 is adapted to activate the at least one light source 508 based on an illumination pattern. For example, the illumination pattern may specify a color, an intensity, and a duration of activation of the at least one light source 508. In certain embodiments where the wearable device 500 includes a plurality of LED units connected to the controller 502, the illumination pattern may specify a color, an intensity, and a duration of activation for each LED unit of the plurality. In particular, the illumination pattern may include a sequence of analog power values each corresponding to the color, the intensity, the duration of activation, and a timing of activation for each LED unit. For any given illumination pattern, the color, the intensity, and the duration of activation for each LED unit of the plurality may be the same, or substantially different.

In particular embodiments, the controller 502 may be adapted to active at least one LED unit, or multiple LED units, responsive to receiving one or more event messages. Furthermore, each illumination pattern may correspond to a particular event message, and in particular, event metadata associated with a particular event message. As discussed above, regular, irregular, or random illumination patterns may correspond to the start of a sporting event, when a player scores, when a team is winning or losing, or when a player assists a goal or point. Illumination patterns may correspond to other events, and metadata associated with those events, such as political events, live events, and celebrity events, as described in more detail above.

Particular examples of illumination patterns for a sports related event and metadata are provided with reference to TABLE 1. Within TABLE 1, “Event” represents the particular sports related event, “LED Unit” represents the illuminated LED unit (e.g., LED1, LED2, LED 3, or LED4), “Time” represents the time of illumination of a given LED unit, “Color” represents the color of the illuminated LED unit (e.g., a first color or a second color), and “Duration” represents the duration of illumination of the LED unit. The units of the duration in TABLE 1 are seconds. In the given examples, the time of illumination begins at a 1st second when a first LED unit is illuminated (i.e., Time=1), each subsequent second is indicated by a counter increase of 1 (i.e., Time=2, then Time=3, then Time=4, etc.). LED units having the same “Time” value will be illuminated concurrently.

TABLE 1

| | LED | | | Duration |
|---|---|---|---|---|
| Event | Unit | Time | Color | (s) |
| When the game tips off | LED1 | 1 | 1 | 2 |
| | LED3 | 1 | 1 | 2 |
| | LED2 | 1 | 1 | 1 |
| | LED4 | 1 | 1 | 1 |
| | LED1 | 1 | 1 | 2 |
| | LED3 | 1 | 1 | 2 |
| | LED2 | 1 | 1 | 1 |
| | LED3 | 1 | 1 | 1 |
| When a player makes a three point shot | LED1 | 1 | 1 | 3 |
| | LED2 | 2 | 2 | 5 |
| | LED3 | 3 | 1 | 3 |
| | LED4 | 4 | 2 | 5 |
| When a player makes an assist | LED1 | 1 | 1 | 1 |
| | LED1 | 2 | 2 | 1 |
| | LED1 | 3 | 1 | 1 |
| | LED1 | 4 | 2 | 1 |
| When the team wins | LED1 | 1 | 1 | 0.25 |
| | LED2 | 1 | 1 | 0.25 |
| | LED1 | 1 | 1 | 0.25 |
| | LED2 | 1 | 1 | 0.25 |

In various embodiments, any of the example illumination patterns may be repeated for any number of iterations.

Similarly, in various embodiments the controller 502 of the wearable device 500 is adapted to control (or provide instructions to the motor controller 512 to control) the vibration motor 510, responsive to receiving an event message via the communication circuitry 504 (i.e., the wireless transceiver). While in one embodiment, the controller 502 may provide a control signal to one of the at least one light source 508 and the vibration motor 510; in various other embodiments, the controller 502 may control both the at least one light source 508 and the vibration motor 510 simultaneously or in succession. In various embodiments, control of the vibration motor 510 causes the wearable device 500 to provide haptic feedback to the user. For example, the wearable device 500 may vibrate or shake. For instance, the vibration motor 510 may cause the wearable device 500 to vibrate based on the following events: start of a sporting event, when a player scores, when a team is winning or losing and, when a player assists a goal or point.

In various embodiments, the controller 502 is adapted to activate (i.e., control) the vibration motor 510 based on a haptic pattern. For example, the haptic pattern may specify an intensity and a duration of activation of the vibration motor 510. In one example, the controller 502 is adapted to generate a pulse width modulation (PWM) waveform based on the haptic pattern to activate the vibration motor 510. In other examples, commands may be provided to the motor controller 512, to generate a PWM waveform. In certain embodiments, the controller 502 may be adapted to activate the vibration motor 510, responsive to receiving one or more event messages. Furthermore, each haptic pattern may correspond to a particular event message, and in particular, event metadata associated with a particular event message. As discussed above, regular, irregular, or random haptic patterns may correspond to the start of a sporting event, when a player scores, when a team is winning or losing, or when a player assists a goal or point. Haptic patterns may correspond to other events, and metadata associated with those events, such as political events, live events, and celebrity events, as described in more detail above.

In various embodiments the controller 502 may automatically, or dynamically, determine the illumination pattern and/or haptic pattern based on the event message or event metadata. For example, the controller 502 may use a look-up table to determine the illumination pattern and/or haptic pattern for a given event. The look-up table may include an array that replaces a run-time computation with an indexing operation. For example, the look-up table may include an array of pre-defined and indexed illumination patterns and/or haptic patterns stored in static program storage. While in some embodiments the controller 502 may automatically, or dynamically, determine the illumination and/or haptic pattern, in various other embodiments such operations may be performed by a user device in communication with the wearable device 500 (e.g., user device 114 shown in FIG. 1). For example, in one implementation the user device may automatically determine an illumination and/or haptic pattern associated with aggregated event metadata, and transmit a corresponding pattern to the communication circuitry 504 of the wearable device 500. In still further embodiments, the controller 502 (or the user device), may create an illumination pattern and/or a haptic pattern based on a received event message or event metadata, or in some instances, a user input.

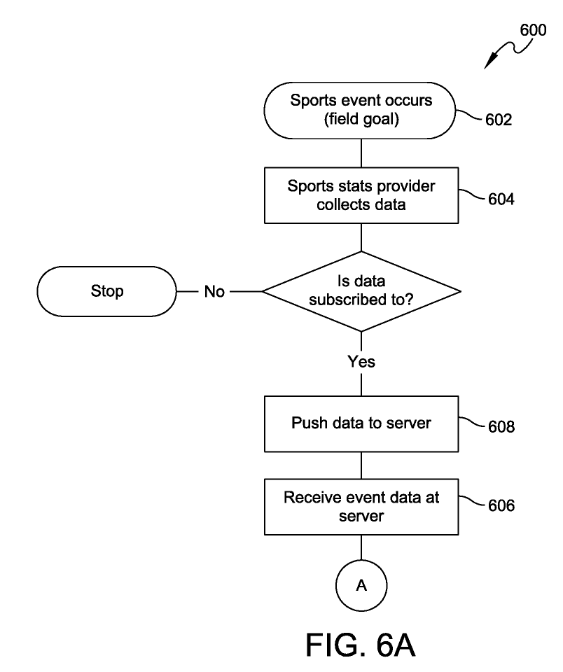

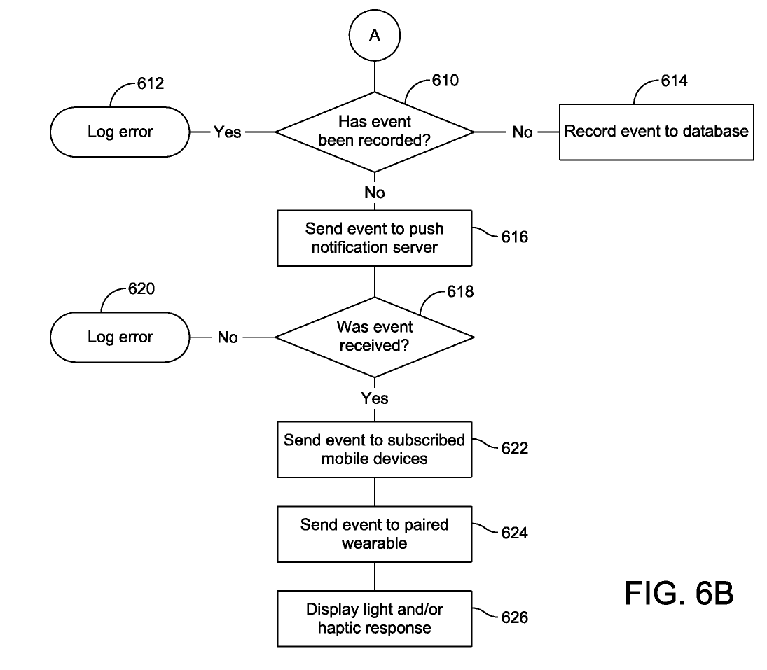

As discussed above, several embodiments perform processes that provide real-time visual or haptic event notifications. In some instances, these processes are performed by a system for real-time event notifications, such as the system 100 discussed with reference to at least FIG. 1. One example of such a process is illustrated in FIGS. 6A and 6B. According to this example, the process 600 may include acts of aggregating event data, receiving event data, serializing and transmitting an event message to a wearable device, and providing a visual and/or haptic notification at a wearable device.

In various embodiments, the process 600 begins when an event occurs, for example, a player in a sporting event scores a goal (act 602). While in various embodiments the event may include a sporting event, in various other examples, events may include other events such as news events, weather events, concert events, celebrity events, political events, live events, and any other suitable events. In various embodiments, one or more content sources 112 generate event data and metadata corresponding to the occurring event (act 604). The process 600 then may include determining if a content source is subscribed to (act 628). If the event notification service 104 of various embodiments is in communication with the content provider 112 (e.g., the content source is subscribed to), the event data and metadata is aggregated and received at the event notification service 104 (act 606). In various embodiments, the process 600 may include pushing the event data and metadata automatically from the content source 112 to the event notification service 104 (act 608). In certain embodiments, the process 600 may also include scraping event data or metadata from one or more content source RSS feeds or websites.

In various embodiments, responsive to receiving the event data and metadata, the process 600 may include determining whether the event has been previously received and/or recorded by the event notification service 104 (act 610). If the event has previously been recorded, an error is logged and the process terminates (act 612); however, if the event has not been previously recorded, the event data and metadata is stored (act 614), and the event data and metadata is communicated to the user device 114. In various embodiments, this may include communicating the event data and metadata to a push notification server 110 (act 616), confirming the event data and metadata was received by the push notification server 110 (act 618), and sending the event data and metadata via push notification to subscribed user device 114 (act 622). If the data and metadata is not successfully received at the push notification server 110, an error is logged and the process terminates (act 620).

In various embodiments, if the event data and metadata is successfully received, the process 600 includes serializing and transmitting an event message to the at least one wearable device 102 from the user device 114 (act 624). As discussed above, the event message may be based at least in part on the event data and metadata received. Responsive to receiving the event message at the wearable device 102, the process 600 may further include providing at least one of a visual notification and a haptic notification (act 626). As discussed above, this may include controlling the one or more LED units 118 and/or the vibration motor 120 according to one or both of an illumination pattern and a haptic pattern. In particular, the illumination pattern may include a color, an intensity, and a duration of activation, for the one or more LED units 118. Similarly, the haptic pattern may include an intensity and a duration for the vibration motor 120. As further discussed with reference to at least the example wearable device 300 shown in FIGS. 3A-3D, activating the one or more LED units may include illuminating a visual indicator (e.g., visual indicator 314) on a display surface of the wearable device.

As also described above with at least reference to FIG. 1, various aspects and embodiments may include a wearable device in communication with a user device that includes controls which perform various functions in an event notification application (e.g., a mobile application) to provide event messages descriptive of event data to the wearable device. Such functions may include processes for prompting a user to initiate and download an event notification application, downloading the event notification mobile application (e.g., from an application store or the event notification service), activating the event notification application, prompting a user to pair the wearable device and the user device, displaying a “pair now” prompt within the event notification application, prompting activation of a pairing button on the wearable device, and providing confirmation that the wearable device and user device are synced (i.e., in communication). In one example, providing confirmation that the wearable device and user device are synced may include providing one of a visual notification or haptic notification, such as activating the one or more LED units and/or the vibration motor.

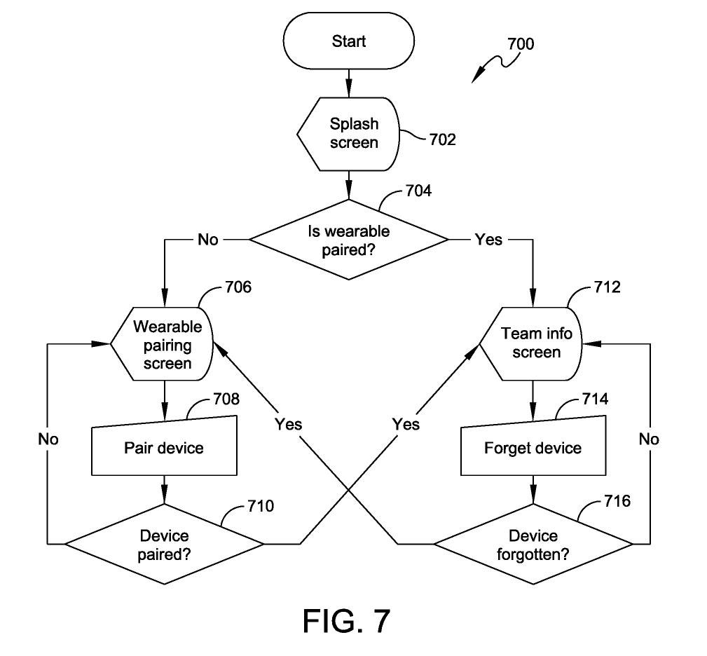

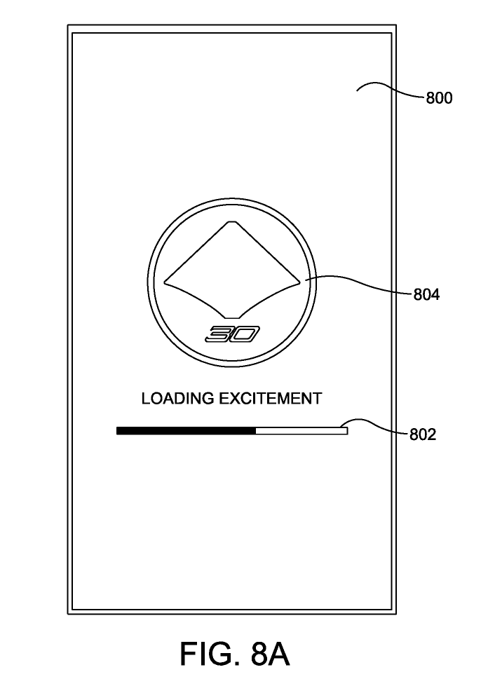

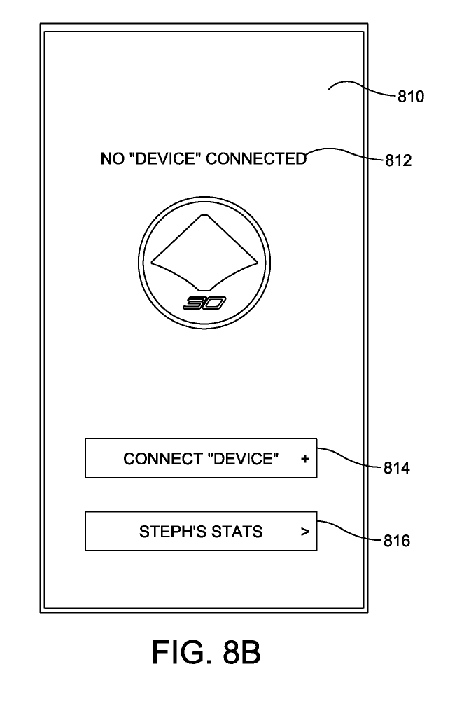

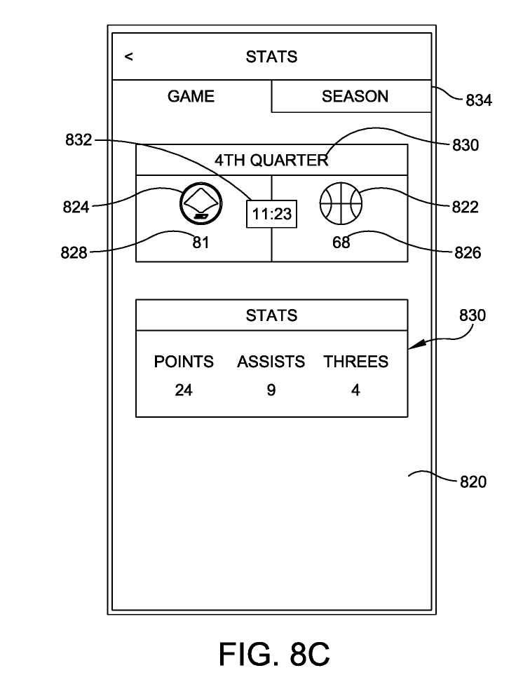

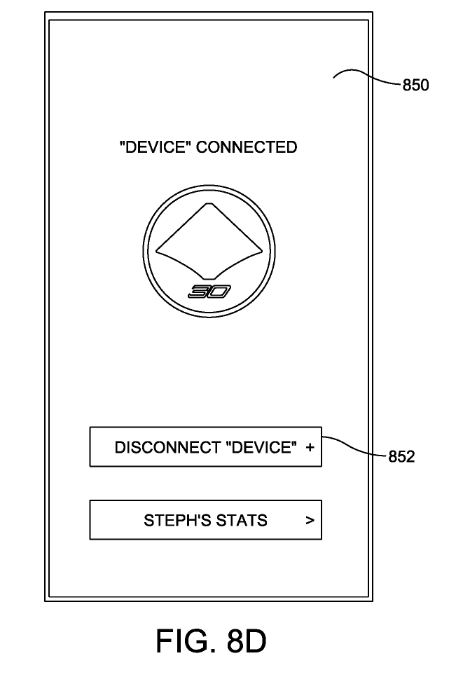

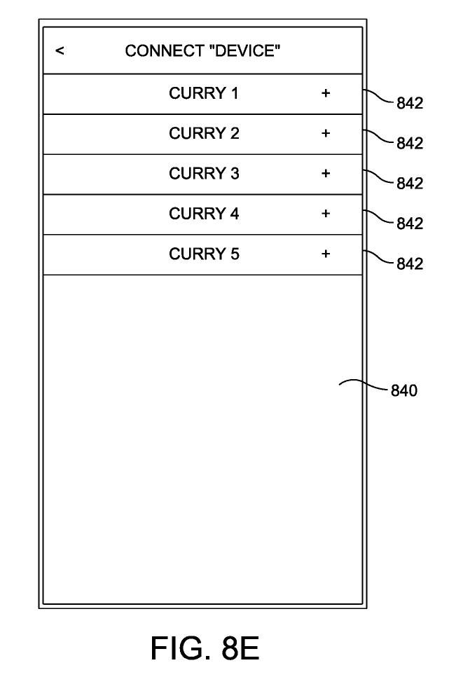

According to various embodiments, a user device, such as the user device 114 described with reference to at least FIG. 1 includes a user display (i.e., user interface) which permits the user to interact via the event notification application with a wearable device, such as the wearable device 102 of FIG. 1. FIG. 7 shows an example process flow for transitions between various displays of the user interface (referred herein as “user interface displays” or “screens”) of the event notification application. Example user interface displays are shown in FIGS. 8A-8D.

In various embodiments, the process 700 first includes displaying a splash screen (act 702). For example, the splash screen may include a loading screen displayed while the event notification application is launching. The process 700 then may include determining whether the user device 104 (e.g., the event notification application executing on the user device 104) has been paired with the wearable device 102 (act 704). If the user device 114 determines that the wearable device 102 has not been paired with the event notification application, the user display transitions to a wearable device pairing screen whereat the user is instructed to pair the user device with the wearable device 102 (act 706). In such a user interface display, the event notification application may provide instructions, or one or more virtual buttons, the selection of which, pairs the user device 114 (e.g., event notification application) with the wearable device 102 (act 708). The process 700 may then include determining whether the wearable device 102 is successfully paired within the user device 102, and is successfully in communication (act 710). If a wearable device 102 is successfully paired with the user device 114, the process 700 includes transitioning to and displaying an event data screen (e.g., team information screen) (act 712). As shown in FIG. 7, in one embodiment the act of transitioning to and displaying and event data screen may also be performed responsive to determining the wearable device 102 is successfully paired with the user device 114 after displaying the splash screen.

In various embodiments, the event data screen provides a series of event data and event analytics. In various embodiments, the event data screen may include statistics for a particular sporting event, such as competitors, score, time remaining, and/or player statistics (e.g., points, assists, and field goals), among other information. In one instance, the event data screen may also include one or more tabs, the activation of which transitions the user interface display of the user interface between one or more arrangements of analytics, statistics, and/or data. In various embodiments, responsive to user selection, or expiration of a time out period, the process 700 may include forgetting the wearable device 102 (act 714). For example, this may include discontinuing communication between the user device 114 and the wearable device 102. Such an instance may also occur when the communication between the wearable device 102 and the user device 114 is interrupted. In such an embodiment, the process 700 may include transitioning to the wearable device pairing screen whereat the user is instructed to pair the user device 114 with the wearable device 102 if the device has been forgotten, or returning to the data analytics screen if the wearable device 102 has not been forgotten (act 716).

Turning now to FIGS. 8A-8D, FIG. 8A shows one example of a splash screen 800. The splash screen 800 may include a loading indicator 802 and one or more visual symbols 804. In some embodiments, the symbols 804 may match a visual indicator of the wearable device. FIG. 8B shows one example of a wearable device pairing screen 810. As shown, the pairing screen 810 may include a status indicator 812 which informs the user whether the wearable device is currently synced with the user device. As also shown, the pairing screen 810 may also include one or more virtual buttons. For example, the pairing screen 810 may include a pairing virtual button 814 and a statistics virtual button 816. In various embodiments, the activation of pairing virtual button 814 transitions the user interface display to a screen including a display of available wearable devices for pairing, such as the screen 840 shown in FIG. 8E. While in one embodiment, activation of the pairing virtual button 814 (and substantially simultaneous activation of a pairing button on the wearable device) causes the user device to pair and sync with the wearable device. In various other embodiments, such processes may be performed responsive to selection of a particular wearable device (e.g., devices 842) listed within the screen 840 shown in FIG. 8E.

Returning to FIG. 8B, in certain embodiments, activation of the statistics virtual button 816 causes the user device to transition to an event data screen which provides an arrangement of analytics, statistics, and/or data associated with an event, event data, or event metadata. FIG. 8C shows one example of an event data screen 820.

Turning now to FIG. 8C, FIG. 8C shows one example of an event data screen 820 for a sports event, and in particular a basketball game. As discussed above, the event data screen 820 may provide statistics for a particular sporting event, such as competitors, score, time remaining, and/or player statistics (e.g., points, assists, and field goals), among other information. FIG. 8C shows the event data screen 820 as showing a first and a second basketball team 822, 824, the points currently scored by each team 826, 828, the current quarter of the basketball game 830, the time remaining in that quarter 832, and a player's (e.g., “Steph's”) current points, assists, and field goals (indicated generally by arrow 830). The example event data screen 820 also may include one or more tabs, such as tab 834, the activation of which causes the user display to transition to another arrangement of analytics, statistics, and/or data.

Similar to the pairing screen 810 illustrated in FIG. 8B, FIG. 8D shows another example of a pairing screen 850 of a user interface display. The pairing screen 850 may include a virtual disconnect button 852, the activation of which disconnects the wearable device from the user device.

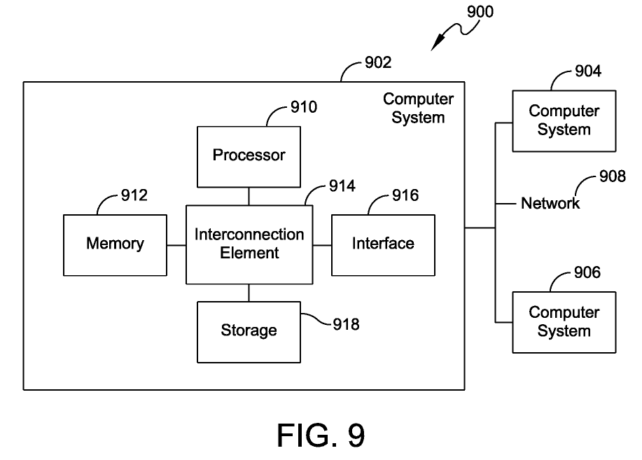

Referring to FIG. 9, there is illustrated a block diagram of a distributed computer system 900, in which various aspects and functions are practiced. As shown, the distributed computer system 900 includes one or more computer systems that exchange information. More specifically, the distributed computer system 400 includes computer systems 902, 904, and 906. As shown, the computer systems 902, 904, 906 are interconnected by, and may exchange data through, a communication network 908. The network 908 may include any communication network through which computer systems may exchange data. To exchange data using the network, the computer systems 902, 904, 906 and the network 908 may use various methods, protocols and standards, including, among others, Fibre Channel, Ethernet, Wireless Ethernet, Bluetooth, IP, IPV6, TCP/IP, UDP, DTN, HTTP, FTP, SMS, MMS, SS7, JSON, SOAP, CORBA, REST, and Web Services. To ensure data transfer is secure, the computer systems 902, 904, 906 may transmit data via the network 908 using a variety of security measures including, for example, SSL or VPN technologies. While the distributed computer system 900 illustrates three networked computer systems, the distributed computer system 900 is not so limited and may include any number of computer systems and computing devices, networked using any medium and communication protocol.

As illustrated in FIG. 9, the computer system 902 includes a processor 910, a memory 912, an interconnection element 914, an interface 916, and data storage element 918. To implement at least some of the aspects, functions, and processes disclosed herein, the processor 910 performs a series of instructions that result in manipulated data. The processor 910 may be any type of processor, multiprocessor or controller. Example processors may include a commercially available processor such as an Intel Xeon, Itanium, or Core processor; an AMD Opteron processor; an Apple A4 or A5 processor; an IBM Power5+ processor; an IBM mainframe chip; or a quantum computer. The processor 910 is connected to other system components, including one or more memory devices, by the interconnection element 914.

The memory 912 stores programs (e.g., sequences of instructions coded to be executable by the processor 910) and data during operation of the computer system 902. Thus, the memory 912 may be a relatively high performance, volatile, random access memory such as a dynamic random access memory (“DRAM”) or static memory (“SRAM”). However, the memory 912 may include any device for storing data, such as a disk drive or other nonvolatile storage device. Various examples may organize the memory 912 into particularized and, in some cases, unique structures to perform the functions disclosed herein. These data structures may be sized and organized to store values for particular data and types of data.

Components of the computer system 902 are coupled by an interconnection element such as the interconnection element 914. The interconnection element 914 may include any communication coupling between system components such as one or more physical busses in conformance with specialized or standard computing bus technologies such as IDE, SCSI, PCI and InfiniBand. The interconnection element 914 enables communications, including instructions and data, to be exchanged between system components of the computer system 902.

The computer system 902 also includes one or more interface devices 916 such as input devices, output devices and combination input/output devices. Interface devices 916 may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 902 to exchange information and to communicate with external entities, such as users and other systems.

The data storage element 918 includes a computer readable and writeable nonvolatile, or non-transitory, data storage medium in which instructions are stored that define a program or other object that is executed by the processor 910. The data storage element 918 also may include information that is recorded, on or in, the medium, and that is processed by the processor 910 during execution of the program. More specifically, the information may be stored in one or more data structures specifically configured to conserve storage space or increase data exchange performance.

The instructions may be persistently stored as encoded signals, and the instructions may cause the processor 910 to perform any of the functions described herein. The medium may, for example, be optical disk, magnetic disk or flash memory, among others. In operation, the processor 910 or some other controller causes data to be read from the nonvolatile recording medium into another memory, such as the memory 912, that allows for faster access to the information by the processor 910 than does the storage medium included in the data storage element 918. The memory may be located in the data storage element 918 or in the memory 912, however, the processor 910 manipulates the data within the memory 912, and then copies the data to the storage medium associated with the data storage element after processing is completed. A variety of components may manage data movement between the storage medium and other memory elements and examples are not limited to particular data management components. Further, examples are not limited to a particular memory system or data storage system.

Although the computer system 902 is shown by way of example as one type of computer system upon which various aspects and functions may be practiced, aspects and functions are not limited to being implemented on the computer system 902 as shown in FIG. 9. Various aspects and functions may be practiced on one or more computers having a different architectures or components than that shown in FIG. 9. For instance, the computer system 902 may include specially programmed, special-purpose hardware, such as an application-specific integrated circuit (“ASIC”) tailored to perform a particular operation disclosed herein. While another example may perform the same operation using a grid of several general-purpose computing devices running MAC OS System X with Intel processors and several specialized computing devices running proprietary hardware and operating systems.

The computer system 902 may be a computer system including an operating system that manages at least a portion of the hardware elements included in the computer system. In some examples, a processor or controller, such as the processor 910, executes an operating system. Examples of a particular operating system that may be executed include a Windows-based operating system, such as, Windows Phone, Windows 7, or Windows 8 operating systems, available from the Microsoft Corporation, Android operating system available from Google, Blackberry operating system available from Blackberry Limited, a MAC OS System X operating system or an iOS operating system available from Apple, one of many Linux-based operating system distributions, for example, the Enterprise Linux operating system available from Red Hat Inc., or UNIX operating systems available from various sources. Many other operating systems may be used, and examples are not limited to any particular operating system.

The processor 910 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Ruby, Objective-C, Java, C++, Ada, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

Accordingly, provided is a system and wearable device capable of generating real-time event notifications. In various embodiments, the wearable device is specially-configured to generate a visual notification and/or a haptic (e.g., vibration) notification responsive to receiving an indication that an event, such as a goal at a sporting event, has occurred. Each event notification may be unique to particular event data (e.g., the start of a game, occurrence of a goal or point, occurrence of an assist, crowd noise, etc.). Such aspects and embodiments provide a user with greater access to more timely and relevant event information, and in particular, to real-time event updates.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A wearable device comprising:
at least one light source;
a display surface in optical communication with the at least one light source;
communication circuitry configured to receive an event message in real-time from a user device; and
at least one controller operatively connected to the at least one light source and the communication circuitry, the at least one controller configured to control operation of the at least one light source based on the received event message.

2. The wearable device of claim 1, wherein the at least one light source includes at least one light-emitting diode (LED) unit.

3. The wearable device of claim 2, wherein the display surface includes at least one visual indicator, and wherein in controlling operation of the at least one light source based on the received event message, the controller is further configured to activate the at least one LED unit based on an illumination pattern specifying a color, an intensity, and a duration of activation, to illuminate the visual indicator.

4. The wearable device of claim 3, wherein the at least one LED unit includes a plurality of LED units, each LED unit of the plurality being independently addressable, and wherein the illumination pattern includes a sequence of analog power values each corresponding to the color, the intensity, the duration of activation, and a timing of activation for each LED unit of the plurality of LED units.

5. The wearable device of claim 4, wherein the event message includes translated event metadata received from a push notification service and associated with an event, and wherein the controller is further configured to dynamically determine the illumination pattern based on at least the event metadata.

6. The wearable device of claim 1, further comprising a housing having an attachment surface including an attachment article configured to selectively fasten the wearable device to a user.

7. The wearable device of claim 1, further comprising a vibration motor, wherein the controller is configured to activate the vibration motor based on the received event message.

8. The wearable device of claim 7, wherein in activating the vibration motor based on the received event message, the controller is configured to generate a pulse width modulation (PWM) waveform based on a haptic pattern to activate the vibration motor for a predetermined intensity and a predetermined duration of activation.

9. The wearable device of claim 1, wherein the communication circuitry includes a wireless receiver configured to receive the event message from the user device via a wireless protocol, wherein the wireless protocol implements a short range piconet.

10. The wearable device of claim 1, further comprising a Near-Field Communication (NFC) chip configured to communicate with the user device according to a near-field communication protocol.

11. A system for real-time event notifications comprising:
a first user device including a memory, a user display, and at least one processor in communication with the memory and the user display, the processor when executing configured to:
receive event data from a push notification service,
serialize and transmit an event message; and
a first wearable device including communication circuitry configured to receive the event message, a controller, and at least one light source in optical communication with a display surface, the controller being configured to control operation of the at least one light source based on the received event message.

12. The system of claim 11, wherein the communication circuitry includes a wireless receiver configured to receive the event message from the user device via a wireless protocol, and wherein the event data includes event metadata received from the push notification service and corresponding to an event.

13. The system of claim 12, wherein the at least one light source includes at least one light-emitting diode (LED) unit, wherein the display surface further includes at least one visual indicator, and wherein in controlling operation of the at least one light source based on the received event message, the controller is further configured to activate the at least one LED unit based on an illumination pattern including a color, an intensity, and a duration of activation, to illuminate the visual indicator.

14. The system of claim 13, wherein the controller is further configured to dynamically determine the illumination pattern based on at least the event metadata.

15. The system of claim 11, wherein the processor of the first user device when executing is further configured to manage interactive display of the event data and event metadata via the user display of the user device.

16. The system of claim 11, wherein the processor of the first user device when executing is further configured to communicate via a multi-peer connectivity network with a second user device, and wherein the first wearable device is configured to sync with a second wearable device, the second wearable device configured to receive the event message from the second user device.

17. A method for real-time event notifications, the method comprising:
aggregating event data;
receiving event data via at least one push notification service at a first user device;
serializing and transmitting an event message to a first wearable device based at least in part on the event data; and
responsive to receiving the event message at the first wearable device, providing one of a visual notification and a haptic notification based on the event message.

18. The method of claim 17, wherein the first wearable device includes a visual indicator in optical communication with at least one light-emitting diode (LED) unit, and wherein providing the visual notification includes activating the at least one LED unit based on an illumination pattern including a color, an intensity, and a duration of activation, to illuminate the visual indicator.

19. The method of claim 17, the method further comprising:
translating event metadata of the event data, the event metadata being associated with an event; and
dynamically determining the illumination pattern based on at least the event metadata, responsive to receiving the event message at the first wearable device.

20. The method of claim 17, the method further comprising:
communicating via a multi-peer connectivity network with a second user device; and
syncing the first wearable device with a second wearable device, the second wearable device being in communication with the second user device.
